(19) United States
(12) Patent Application Publication
(10) Pub. No.: US 2009/0272628 A1
(43) Pub. Date: Nov. 5, 2009

(54) DEVICE AND METHOD FOR VERTICAL TRANSPORTATION OF PARTICULATE MATERIALS

(76) Inventor: Rolf Birketvedt, Vettre (NO)

Correspondence Address: DENNISON, SCHULTZ & MACDONALD, 1727 KING STREET, SUITE 105, ALEXANDRIA, VA, 22314, US

(21) Appl. No.: 12/377,482

(22) PCT Filed: Aug. 16, 2007
(86) PCT No.: PCT/NO07/00285

§ 371 Date: Feb. 17, 2009

(30) Foreign Application Priority Data
Aug. 16, 2006 (NO) 20063680

(51) Int. Cl. B65G 33/14

(52) U.S. Cl. 198/657

(57) ABSTRACT

Device for vertically upward transportation of particulate materials with a substantially uniform particle size and shape, comprising a substantially vertical pipe with a stirrer arranged concentrically within said pipe with a clearance between the pipe wall and the outer parts of the stirrer, said clearance being at least 1.5 times the smallest uniform particle dimension. Method for vertically upward transportation of particulate materials with a substantially uniform particle size and shape, with the use of said device, comprising i) filling the vertical pipe at least partially with the particulate material having substantially uniform particle size, ii) rotating the stirrer with a velocity adapted to fluidize the particulate material, iii) initiating feed of particulate materials to be conveyed through the feed device, and iv) adjusting the feed rate of the feed device such that fluidization and thereby transportation is maintained in the vertical pipe.

The present invention relates to device and method for vertical transportation of particulate materials.

### BACKGROUND

In U.S. Pat. No. 5,368,153 there is described a vertical transport device comprising a shaft less helix screw arranged in a vertical pipe enclosure with a small clearance between the pipe wall and the helix. The particulate material that is conveyed in such a device will be conveyed by the helicoid action of the helix, i.e. rotating upwards with vortex horizontal motion components as well as vertical movement. There will be considerably wear on particles that are exposed to such forced movement, both in state of friction between particles, friction between particles and conveyor, and between particles and pipe wall, especially when coarse and/or large particles are conveyed.

It is a prevailing view and experiences that vertical augers/conveyors with helix wear and crushes a portion of coarse particles that are conveyed. Therefore, other methods are commonly used for vertical conveying of coarse particles. In Cema book no. 50, chapter 7, published in 2003 by Conveyor Equipment Manufactures Association, it is not recommended to convey materials with high density, large particles or wearing particles in a vertical helix screw conveyor.

### OBJECTS

It is an object of the present invention to provide a device and method for vertical transportation of particles with use of low power and low wear on the particles. It is further an object to enable this by simple means with low maintenance input in a device that can be mounted with inexpensive parts.

A derived objective is to provide a device that is suitable for safe feeding of wood pellets to a combustion plant for such fuel.

### PRESENT INVENTION

The above mentioned purpose is achieved by the present invention that according to a first aspect includes a device according to claim 1.

According to a second aspect, the present invention concerns a method according to claim 12. According to a further aspect, the present invention relates to use of the device according to the invention's first aspect as described by claims 22 and 24.

Preferred embodiments of the invention are disclosed by the dependent claims.

The smallest uniform particle size can be the diameter of the pellets, the radius of spherical particles or the smallest dimension in one direction of a particle with other shape, such as rotational bodies with elliptical or oval cross-sections and/or particles with other, non-spherical shape.

A central element of the present invention comprise a mainly helix shaped stirrer that has a cross section, or more adequately, a projected cross section that is considerably smaller than the inner section of the pipe it is arranged in. The projected cross section means here the stirrer's area within its outer periphery at a given vertical level and through a complete 360 degree rotation around its imaginary axis.

The function of the stirrer can be compared to the screw helix in a traditional screw conveyor, but since there is a considerable clearance between the outer edge of the stirrer and the pipe wall, there is no considerable forced feeding of material against the pine wall in this device and the wear on the particles shows to be low. This is the reason why the stirrer is called a stirrer and not a screw conveyor. Actually it was not obvious for the inventor that the invention would function in this desired manner and it was a surprise that it not only works well but there is also low wear on the particles.

When studying the movement to the individual particles conveyed with the device according to the present invention, it is apparent that the particles move substantially linear within the stirrer's projected cross section. Without fully understanding the mechanism, the stirrer seems to fluidise the particulate material to a certain extent, this meaning that it eases a small, but significant lift in the material and a corresponding reduction of the bulk weight involving less friction between the particles when they move among themselves.

A further identification character in the invention is that particulate materials gather outside the circumference of the stirrer and stays mainly at rest in this area while taking shape as a “holster” round the particles inside the circumference of the stirrer.

Another identification character in the invention is that when a certain amount of fines is applied in the feed material, such as dust and wear particles from the material conveyed etc, this material will gather partly in the bottom of the device and partly outside the stirrer's circumference, and to negligible extent be transported through the device. This has apparent advantages that will be discussed in the following.

The invention can be applied different processes where gentle vertical movement of particulate materials is desired, also for coarse grained materials such as for instance pellets or granulate. The invention can also be applied when there is a desire for different treatments or combinations of different treatments such as sifting, cooling, gas treatment, heat treatment, drying, combustion and transport of materials. The device can also be uses as a tool for analysis of particulate materials properties.

In the following, a particular embodiment is illustrated with reference to accompanied figures, where:

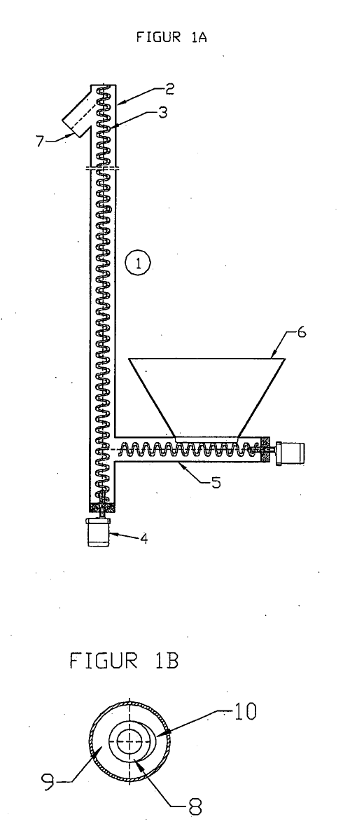

FIG. 1a is a side sectional cross view of a device according to the present invention.

FIG. 1b is a horizontal sectional view of the device in FIG. 1 at a random vertical level.

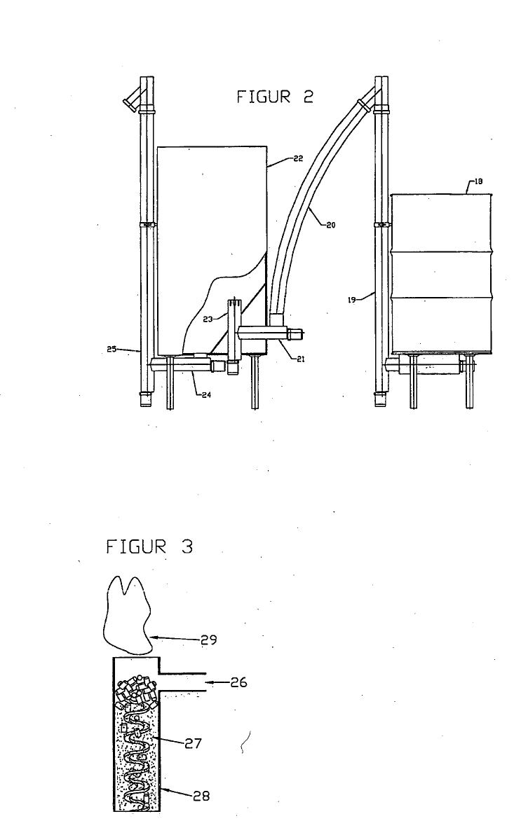

FIG. 2 shows the device according to the invention in connection with a pellets combustion plant.

FIG. 3 shows a variant of the device according to the invention where the upper part of the pipe is designed as a burner for pellets.

The device 1 generally comprise a substantially vertical pipe 2 that envelopes a stirrer 3 with clearance between the stirrer's outer periphery and the pipe 2 inner wall. The stirrer 3 is driven by a motor 4 that can be arranged above the pipe 2 or under the pipe 2. The stirrer 3 does not have to be resting in bearings in its end opposite the end connected to the motor, but it can be. It should be underlined that even if it is common and very simple to use a pipe with a circular cross section, this is not a presumption with the present invention. One can use a pipe with circular cross section, elliptical cross section, octagonal section or in principal whatever shape of the cross section. It is even possible, if not practical, to use a pipe with extended elliptical cross section, with to or more stirrers placed side by side along the long axis of the elliptical shape, and with at least one outlet near the top for each of the stirrers.

A feed device 5 shown as a conventional screw conveyor is arranged close to the lower end of pipe 2. The feed device 5 is typically supplied with material from a container or silo 6 by gravity. The feed device has typically controlled feed capacity in order to adjust the capacity to the requirement and capacity of the vertical conveyor. A characteristic property of the invention is that the capacity of the feed device 5 is controlled at such a low capacity in order to maintain the fluidising effect in a substantial height of the vertical device, this to ensure that particles in the outer periphery are kept at rest. One should not feed in more horizontally than what is fed vertically, in that case the fluidising effect will fail. Close to the top of the pipe 2, an outlet 7 can potentially consist of a closed pipe dropping the particles to for example at burner in a furnace for biomass (pellets).

As derived from FIG. 1b, the area within the stirrer's (outer) periphery (at whatever vertical level) is generally referred with reference number 8 and the area outside is referenced 9. FIG. 1b indicates the possibility of extending the circumference locally some places to create an extra “lift” in the material, see the deviation from circular circumference in the right side of figure

For illustration purpose, the vertical extent of pipe 2 is shown arranged in three sections, one lower section A, one middle section B and an upper section C. It should be pointed out that there are no absolute limits between the mentioned sections which are included to illustrate the following. When or if a fine particulate material, intentionally or unintentionally, is fed into the vertical pipe together with the particulate material to be transported, these fines will after some time distribute with most of the fines in section A of the pipe, less in section B and the lowest concentration of fines in section C. Furthermore—an also after longer running period, there will be a radial concentration gradient, with high fine concentration against the pipe wall in the periphery of area 9 and a lower concentration towards the centre of the pipe in area 8. The lowest concentration of fine particles will be in the upper section C of the pipe, within the stirrer's 3 (outer) circumference. Therefore, at normal operating conditions, there will only be very small amounts of fines transported through the pipe and this amount is approximately equivalent to the amount that potentially follows the in feed of the coarse material through the feed device. If there is to be transported a coarse particulate material which naturally consists of for example 3% fines by weight, a balance between fines and coarse particles will be created, after a longer operating period with a major portion of fine particles.

In the lower part of pipe 2, there will typically be a high concentration of fine particles, this can in some instances be highly desirable. In section C, i.e the area where the in feed device enters the pipe 2, there will be a build up of the fines particles which create a gas tight barrier/valve of fines. This can be of positive importance for certain applications.

In this respect, it is described in technical literature (CEMA book no. 50), that granulated or pellets material can roll down towards the bottom of a vertical conveyor when it is stopped and this can cause a starting problem. With the present invention, the vertical pipe has a 100% filling degree which means that the particulate material is at fully rest when conveyor stops and at start, only a low starting torque is required due to the fluidising effect.

The lifting capability for the stirrer is considerably lower compared to traditional vertical screw conveyors but traditional vertical conveyors have other disadvantages, especially in case of transporting materials that need gentle transport. The present invention has typically a volumetric efficiency of 30%, just as well below 25%, while other vertical screw conveyors operates at figures closer to 50%. This implies that the stirrer rotates substantially more rounds to account for a given volume of particulate material from inlet to outlet, but thanks to the fluidising effect, the resistance and thereby the energy usage is still advantageous.

When the particulate material to be transported, intentionally or unintentionally is mixed with fine particulate materials, a sifting action takes place and gives the effects described above with regards to where the fines concentration is high and low. Without necessarily understanding all sides, the phenomena can also be described as segregation. The effect is in any case that coarse particles tend to move quickly through the pipe while the fine particles are withheld. Again, and without clearly proving this, it seems that the fine particles contribute to “lubricate” the transport so that the fluidising effect is increased and the resistance less.

FIG. 2 shows a built-up incineration plant for solid fuels as pellets with a feed system, burner plant and ash output device. In this application, it is assumed that fine particles are present in the vertical pipe 2. The vertical pipe 2 is used in both the feed system for the solid fuel, in the burner 23 mounted in the boiler 22, and in the ash output device 25. The movement of both the solid fuel and ash is vertically and this is space efficient. The valve function created by fines in the vertical device 1, is used in the solid fuel feed system, in the burner 23 and in the ash output device 25.

The valve function prevents false air to be drawn into the burner chamber from the ash feed, the burner and the solid fuel feed system. This gives a good control of the burning process and one can pressurise the burning process. The valve function prevents exhaust gases to leak through the ash output device and the feed system and reduces the risk for backfire through burner and feed system. The valve function can be used in the feed system in order to set silo 6 under vacuum in connection with a pneumatic transport system which transport the solid fuel from an external storage to the silo 6.

Solid fuel from the vertical device 1 is gravity discharged through an ascending pipe 20 and is fed into the burner 23. In the burner 23, pellets will be moved vertically through fines of ash. The finest ash particles are sifted downwards and outwards towards the inner pipe wall in the burner 23 and create a protective holster where the particles here are kept in rest against the pipe wall. The fuel, for example pellets or oat, is sifted up through fines of ash and is fired in the upper part of the burner 23.

If the silo 6 as shown in FIG. 2 is exposed to vacuum, for example by use of pneumatic transport to silo 6, fines in the lower part of the vertical pipe 2 will create a “valve” to such an extent that very small leakage through the vertical pipe 2 will occur. If silo 6 is pressurised with air, the air will anyway penetrate though the mass in the vertical pipe 2. The fine particles function as a non-return valve.

Through testing the invention, it is found that the stirrer's ability to transport the particulate material, i.e the “lifting capability”, seems to be reduced with height of the device, this can be compared to a pressure fall in a pipe where fluid is pumped. The “lifting capability” can be increased by increasing the speed of the stirrer 3, but the speed of stirrer 3 must be limited in such a way that the “lifting capability” does not move the holster of resting fines into the transport path. In this case, the device will work outside this inventions range of action.

Dimensioning of a plant and optimising parameters for individual applications can be done by a professional based on experience.

To increase “lifting capability” on stirrer 3, this can be accomplished by increasing projected cross section, the diameter, increasing stirrer speed, installing motors in both ends with different speeds, or a combination of the mentioned actions. In FIG. 1, cross section C-C, it is shown how the lifting capability can be increased by mounting segments 10 to the stirrer 3. Mounting the device by series in height can also be of interest in order to increase total lifting height.

A sectional view in FIG. 3 is showing a burner embodied as the upper part of the device according to the present invention. The supply of air is here through duct 26. Ash 27 in the burner's pipe 28, creates an inert atmosphere during supply of solid fuel, it insulates against heat and prevents backfire towards feed screw 21 which is only shown in FIG. 2. Flue gases are set on fire and cause the flame 29.

The device, according to the invention, can additionally be used just for transportation, it can be combined with for example, but not limited to, analysis of particulate materials, fluidisations capability, segregation capability or particle size distribution, sifting, cooling, air treatment, heat treatment, drying, combustion and transportation of the materials.

The stirrer can designed hollow for cooling water, hot oil, steam or air in order to lead energy from the material and to heat/dry/cool this. Alternatively, a jacket can be installed onto pipe 2 for leading away or supply energy.

The pipe 2 can possibly be perforated or grooved in order to drain fines from the pipe 2 while the particulate material with substantially uniform size are moved towards outlet 7.

Fine particles from for instance a combined sifting- and drying process can be fed back as recirculation in the drying process while fines from the cooling process can be sifted from a final product, for example a granulate material.

By introducing gases, steam, liquids or other additives direct into the vertical pipe 2 or in the material before the vertical pipe 2, the properties of particular material can be modified through operations as agglomeration, conditioning and granulation.

The device can be used as an analysing instrument for particulate materials. The pipe 2 can, as an example, be split into to half lengths in order that the pipe 2 can be opened for sample taking and analysis. Sampling of the material can be done and one can examine material properties such as particle size distribution, fluidising capability, segregation capability, energy demand, capacity etc.

The device according to the invention can with great advantage be uses for vertical transport of particulate materials where there is high requirement for controlled feed rate and gentle handling of materials.

### EMBODIMENTS

It should be pointed out that the preferred embodiments as described in the following, does not embrace all possible embodiments of the present invention.

While it is necessary with a clearance of at least 1.5 times the smallest uniform particle dimension between the stirrer and inner pipe wall, it is preferred with at least 2 times the smallest uniform particle dimension and even more preferred at least 3 times the smallest uniform particle dimension.

The stirrer must be of a type capable of leading to a form of fluidising of the particulate material with substantially uniform particle size and shape, and is preferably helix shaped.

The stirrer must extend lengthwise in considerably part of the vertical pipe and preferably in the major part from the inlet feed device to the outlet.

The inlet feed device can in principal be whatever type of device capable of feeding particles to the inlet of the vertical pipe. An appropriate and preferred embodiment consists of a screw conveyor substantially horizontally arranged.

It is practical that the capacity of the inlet feed device over time does not exceed a capacity from the upper outlet in order to avoid a pressure in the pipe thus preventing fluidising.

The exact dimensions of pipe 2 and stirrer 3 must be adapted to the appropriate application and the prevailing conditions, particle size etc. It has been observed that major clearance between the stirrer and pipe wall is advantageous and in the cylindrical area outside the stirrer's circumference should constitute more than 20% of the total cross-section of the pipe and preferably 40-95% of the total cross section of the pipe and most preferably 60-90% of the total cross-section of the pipe.

According to the invention, the stirrer in the device lead to a transport of the particulate material mainly within its circumference, as the cylindrical volume between the pipe and circumference of the stirrer form a holster with a majority of stationary particles which create a transport duct for the stirrer. The movement of the particles is substantially vertical.

The volumetric efficiency of the transport in the vertical pipe is according to the present invention typically lower than 30% and can just as well be lower than 20%.

The stirrer's shape and cross section can be uniform from bottom to top, but can also have a shape that varies in vertical extension, typically a variation that leads to increased lift or increased fluidising in the upper part of pipe 2, this can for instance be achieved by a slight increase of the stirrer's (projected) cross section from bottom to top.

The particulate material can have many different shapes, but should mainly be of homogenous size. Most typical configurations for the particles are spherical particles, particles in shape of rotation bodies with oval cross section (such as medicine tablets of various lengths, width and thickness) including pellets with substantially uniform diameter. There is no requirement that also the pellet length shall be consistent as long as the variations are not too great.

Coarse and uneven particles such as wood chips can also be used in the device as long as these particles are sifted up through fine particles and that fines in considerable amounts are in place in pipe 2 before coarse particles are fed into the feed device 5. The fines work as “fluidising aid” in such a case.

Prior to start, the particulate material with substantially uniform size will often be filled up manually in the vertical pipe. The particulate material with substantially uniform size can, however, also at start up be drawn/lifted up in the pipe—completely or partly—through the feed device and with assistance of the stirrer.

As mentioned, it is often advantageous with presence of fine particulate material in the vertical pipe, among other things as a fluidising aid and as a gas barrier. At least for a limited time, the vertical pipe will often be supplied with fines separately or as a wear product of the particulate material with substantially uniform size, where it creates a gas-tight barrier in the lower part of the vertical pipe.

For a limited time span, a relative portion of fine particulate material of 10-70 percent by weight of the particulate material with substantially uniform size will be introduced to the vertical pipe, separately, manually, and/or through the feed device.

The capacity of the feed device and the speed of the stirrer should be adjusted in such a manner that the particulate material with substantially uniform size are moved substantially through the fine particulate material, when such is present, through a segregation process.

In practice, the speed of the stirrer 3 and the feed device 5, are adjusted in such a way that the stirrer 3 transports the up through the vertical pipe 2 with approximately the same capacity as the feed device 5 feeds in the particulate material (steady state).

The speed of the stirrer 3 can be adjusted in such a way that the amount of fines including the particulate material with substantially uniform size at top level of the vertical pipe 2, corresponds to the fraction of the fines that are fed into the device. This means that the portion of fines material in the vertical pipe is constant or mainly constant over time.

While the device 1 according to the invention is principally described “solely” for transportation, it would be obvious for an expert that it also can be combined in processes chosen from drying, cooling, agglomeration or absorption.

A typical application of the device 1 according to the invention is to feed fuel pellets to a burner/boiler. The gas tight barrier of fines particles are in this connection important both to prevent fume leakage and backfire in case of excess pressure in the furnace and that one as a matter of fact can use over pressure in the burning process without risk for fume leakage.

The fine particulate material can as an example consist of ash and/or dust from fuel pellets, as well as series of other fine particulate materials with varying size, density etc, as long as the particle size is considerably smaller than particulate material with substantially uniform size. According to the invention, the device can also be used as a tool or instrument to analyse particulate materials properties fluidising ability, segregating ability or particle size distribution as well as a facility for sifting, cooling, air treatment, heat treatment, drying and/or burning particulate materials.

### EXAMPLES

Tests have been carried out with transport of wood pellets with a diameter/length of 8 mm×approx. 15 mm vertically in a height of 1500 measured between inlet (15) and outlet (5, 6).

The tests were carried out in the following different configurations and with following results:

A) Pipe in the device 1 with inner diameter of 69 mm, stirrer 3 with outer diameter 39 mm, stirrer speed 32 rpm. Clearance between pipe wall and stirrer is 1.8 times particle size. Capacity from the feed device: 12 kg/hour increasing to 18 kg/hour. Annulus outside the circumference of the stirrer constitutes 68% of the total cross section of the pipe.

### Method and Result:

In the above configuration, the device does not function unless considerable amounts of fine particles initially are introduced into the device 1 from the feed device. At a capacity of 12 kg/hour, the device operates perfectly and with low power demand. A holster of fines gathers towards the pipe wall and after a time, the holster of particles stays mainly at rest. The particulate material fluidises and pellets move upwards and are slowly sifted through fines with low friction between the particles.

When increasing the feed capacity from 12 to 18 kg/hour, the power demand highly increases. The fluidising effect fails; the friction between the particles increase and the motor is not able to turn the stirrer. The device does not work according to the principles.

B) Configuration as above but the stirrer has an outer diameter of 53 mm and feed capacity of 12 kg/hour. The clearance between the stirrer and pipe wall is 1 times the particle size. The holster outside the circumference of the stirrer constitutes 41% of the total cross section of the pipe.

### Method and Result:

The device 1 is supplied with considerable amounts of fines before feeding of pellets. When pellets are fed through the feed device, the stirrer operates at high torque and crushes particles. A holster of resting particles against the pipe wall is not created. The device is not operating according to the principles in the invention.

C) Configuration as in A), but pipe with 110 mm in diameter. Feed capacity is 12 kg/hour. Clearance between the stirrer and pipe wall is 4.4 times the particle diameter and the holster outside the stirrer constitutes 87% of the total cross section of the pipe.

### Method and Result:

The device is supplied with pellets together with fines (approx. 3% by weight) through the feed device. The stirrer transports the pellets very easily upwards and substantially within the stirrer's periphery. During filling of the pipe, pellets fall out of transport duct, they move towards the pipe wall and are mainly kept at rest. Through a long time of operation, the device is filled up with fines that are a natural part of the pellets supplied and which is sifted out against the pipe wall and replace pellets which are sifted towards the transport duct of the device. Fines are after a while staying at rest against the pipe wall, barely moving.

D) Configuration with pipe of 110 mm in diameter, stirrer with outer diameter of 69 mm, speed of stirrer at 38 rpm, feed capacity at 48 kg/hour. The clearance between the stirrer and the pipe is 2.56 timer the particle diameter and the holster outside the circumference of the stirrer constitute 61% of total cross section of the pipe.
Result: The device is operating satisfactory

1. Device for vertically upward transportation of particulate materials with a substantially uniform particle size and shape, characterized in comprising a substantially vertical pipe with a stirrer arranged concentrically within said pipe with a clearance between the pipe wall and the outer parts of the stirrer, said clearance being at least 1.5 times the smallest uniform particle dimension.

2. Device as claimed in claim 1, characterized in that the clearance between the stirrer and the pipe wall is at least 2 times the smallest uniform particle dimension and preferably at least 3 times the smallest uniform particle dimension.

3. Device as claimed in claim 1, characterized in that the stirrer has a substantially helical shape.

4. Device as claimed in claim 1, characterized in that the stirrer extends substantially the entire length from the feed device to the discharge opening.

5. Device as claimed in claim 1, characterized in that the feed device comprises a conveyor screw with a mainly horizontal orientation.

6. Device as claimed in claim 1, characterized in that the feed device capacity is arranged to not exceed the volume of discharge at the upper end of the vertical pipe.

7. Device as claimed in claim 1, characterized in that the cross-sectional area of the annulus outside the stirrer in the vertical pipe in an arbitrarily chosen cross-section constitutes more than 20% of the entire cross-sectional area of the pipe and preferably 40-95% of the entire cross-sectional area of the pipe.

8. Device as claimed in claim 1, characterized in that the stirrer transports particulate material mainly within its periphery and that the annulus between the stirrer and the pipe acts as a holster of substantially stagnant particles forming a transport gateway around the stirrer.

9. Device as claimed in claim 1, characterized in that the volumetric efficiency of the transportation in the vertical pipe is less than 30%.

10. Device as claimed in claim 1, characterized in that the shape and cross-section of the stirrer is substantially uniform from its lower end to its upper end.

11. Device as claimed in claim 1, characterized in that the (projected) cross-sectional area of the stirrer is moderately increasing from its lower end to its upper end.

12. Method for vertically upward transportation of particulate materials with a substantially uniform particle size and shape, utilizing a device according to claim 1, comprising the steps of:
filling the vertical pipe at least partially with the particulate material having substantially uniform particle size,
rotating the stirrer with a velocity adapted to fluidize the particulate material,
initiating feed of particulate materials to be conveyed through the feed device, and
adjusting the feed rate of the feed device such that fluidization and thereby transportation is maintained in the vertical pipe.

13. Method as claimed in claim 12, characterized in that the particulate material has a shape chosen among spherical particles of substantially uniform size, particles with shape of rotational bodies having oval cross-section and substantially uniform size, and pellets with a common diameter.

14. Method as claimed in claim 12, characterized in that the particulate material with substantially uniform size at start-up is manually filled, wholly or partially, into the vertical pipe.

15. Method as claimed in claim 12, characterized in that the particulate material with substantially uniform size at start-up is filled, wholly or partially, into the vertical pipe by means of the feed device and assisted by the stirrer.

16. Method as claimed in claim 12, characterized in that fine-grain particulate material, in at least a limited period of time, is fed to the vertical pipe separately or as a wear product from the particulate material of substantially uniform size, and is allowed to form a substantially gas-tight barrier in the lower part of the vertical pipe.

17. Method as claimed in claim 16, characterized in that fine-grain particulate material, in at least a limited period of time, is fed along with the particulate material of substantially uniform size in a relative amount in the range 10-70% by weight of the particulate material of substantially uniform size.

18. Method as claimed in claim 16, characterized in that the capacity of the feed device and the rotational speed of the stirrer are adapted to one another so that the particulate material of substantially uniform size is transported through the fine-grain particles by means of segregation processes.

19. Method as claimed in claim 12, characterized in that stirrer speed and the speed of the feed device are so adjusted that the stirrer transports the particulate material of substantially uniform size upwards in the vertical pipe with about the same capacity that the feed device feeds the particulate material.

20. Method as claimed in claim 16, characterized in that the stirrer speed is so adjusted that at the top of the vertical pipe an amount of fine-grain particles that corresponds to the fraction of fine-grain particles fed to the vertical pipe, is discharged.

21. Method as claimed in claim 12, characterized in that the particulate material during its transportation is subjected to a treatment chosen among drying, cooling, agglomeration or absorption.

22-25. (canceled)
